(19) United States
(12) Patent Application Publication
(10) Pub. No.: US 2015/0207358 A1
(43) Pub. Date: Jul. 23, 2015

(54) WIRELESS CHARGING MOLDULE FOR A STORAGE BATTERY

(71) Applicants: Jung-Tsung LIN, New Taipei City (TW); Ding-Kan CHANG, Taipei City (TW)

(72) Inventors: Jung-Tsung LIN, New Taipei City (TW); Ding-Kan CHANG, Taipei City (TW)

(21) Appl. No.: 14/446,757

(22) Filed: Jul. 30, 2014

(30) Foreign Application Priority Data
Jan. 17, 2014 (TW) 103201063

(51) Int. Cl. H02J 7/02; H02J 7/00

(52) U.S. Cl. CPC H02J 7/025; H02J 7/007; H02J 7/0045; H02J 7/0054

(57) ABSTRACT

The wireless electric charging module for a storage battery takes advantage of a voltage sensing circuit and a current sensing circuit to get an error control signal, through a controlled calculation method (PID), the storage battery can be efficiently controlled to get a direct electric power source for wireless sending in electricity charging, to thereby overcome the phenomenon that the voltage of the storage battery is overly low and unstable in conventional techniques and needs a voltage rise circuit to get a stabilized electric power source, and to overcome the problems in relating to the cost of circuits and the efficiency of conversion of energy.

### BACKGROUND OF THE INVENTION

1. Field of the Invention

The present invention relates to a wireless electric charging module for a storage battery, and especially to a wireless electric charging module used to directly make the storage battery an electric power source for wireless sending in electricity charging, so that it can be used for wireless charging of an external electronic device.

2. Description of the Prior Art

As science and technology advances, using rate of portable electronic products such as intelligent mobile phones, tablet personal computers etc. gets more and more popularized, and people rely more and more on these electronic products as their tools for recording, communication, social contacting and networking, they really become the necessary equipments carried on people themselves' persons in modern lives.

The above mentioned portable electronic products definitely are relied on by people because of getting stronger in their functions day by day; however, they temporarily have an inconvincible problem by being limited of their electric power source. When a user is going out of a room, he often needs to carry with himself transmittal wire sets in order to get an electric power source at any time for charging the electronic products. The mode of carrying with oneself transmittal wire sets when in walking of a user, even when at some places which do not provide hubs for connecting the electric power source, he still is unable to do charging. Therefore, movable electric power source products to be provided and carried on users themselves' persons becomes the necessary equipments carried on people themselves' persons who highly rely on portable electronic products.

Basically, the so called movable electric power source is a storage battery (lithium battery) having output/input ports (e.g.: USB PORTS), the electric power stored in advance in the storage battery can be put out to provide for a portable electronic product through the output/input ports and a transmitting wire set for charging; however, in this situation, users still have the space to improve convenience in addition to carry on themselves' persons movable electric power sources, that is, transmittal wire sets still are the necessary equipments for charging.

In view of inconvenience to use transmittal wire sets, in the recent years, a comparatively novel electric power source solution method is: to provide on a portable electronic product with a wireless transmittal charging module in order that the portable electronic product can be charged in a wireless mode. However, mobile phones or tablet personal computers etc. having wireless transmittal charging modules need to be provided with their special wireless charging seats for performing wireless charging, these do not increase convenience as to the idea of the portable-movable electric power source.

The primary idea of the present invention is to provide a wireless electric charging module on a storage battery, in order that the storage battery can be used as an electric power source for wireless sending in electricity charging, so that the storage battery can be used for wireless charging an external electronic device. During the process of designing, the inventor referred to specifications of the patent U.S. Pat. No. 7,298,361 and Wireless Power Consortium (WPC), while because the voltage of the storage battery is overly low and unstable, in the circuit designing of the present technique, a voltage rise circuit is wanted to get an electric power source, this not only increases the cost of the circuit, but also lowers the efficiency of conversion of the electric power source.

In practice, using the voltage rise circuit and the wireless electricity charging are both one of energy conversion methods, thereby in circuit designing, it is probable not to use a voltage rise circuit, but to use sensing the quantity of voltage of a battery, and through operation of the voltage cooperating with sensing of current and disposing of the operation, and to receive the data transmitted back from the external electronic device and through a calculation method for electric power control, the requirement of the specifications available presently can be coincided with.

### SUMMARY OF THE INVENTION

The object of the present invention is to provide a wireless electric charging module of a storage battery which charging module uses a voltage sensing circuit to get the voltage parameter, and uses an L/C harmonic vibration circuit to receive an error parameter transmitted back from the external electronic device, and uses a current sensing circuit to get the electric current parameter in operation, then the above three parameters are transmitted to an electric power control unit, and through a controlled calculation method (PID) to calculate and get electric power mated with that required by the external electronic device, the electric power then is converted to a quantity of frequency to control a driving circuit to drive the L/C harmonic vibration circuit for generating suitable wireless electric power to be provided for and accepted by the external electronic device, in order that the efficient of wireless electric charging can be the best.

In order to achieve the above mentioned object, the wireless electric charging module of the present invention for a storage battery can be used to control the storage battery to make it a direct electric power source for wireless sending in electricity charging, and to provide electric power for operation of the external electronic device or for charging; wherein the external electronic device has the function of receiving electric power in the wireless mode, and can transmit back an error controlled data signal. The wireless electric charging module of the storage battery includes:

an electric power source circuit that can convert the electric power stored in the storage battery into a stabilized voltage to be provided for use of the electric power control unit (such as CPU), in order that the electric power control unit can generate a frequency output which pushes an L/C harmonic vibration circuit through a driving circuit;

the L/C harmonic vibration circuit can use the features of the frequency and the curve of the L/C harmonic vibration to convert the electric power transmitted by the driving circuit into a harmonic vibration electric power source signal to be emitted and put out in a wireless mode, and to be provided for and accepted by the external electronic device and for charging, while the L/C harmonic vibration circuit can receive the error controlled data signal transmitted back from the external electronic device, and further transmits to a demodulation circuit;

the aforesaid demodulation circuit can demodulate and convert the error controlled data signal received by the L/C harmonic vibration circuit and transmit to the electric power control unit;

a voltage sensing circuit which is electrically connected with the storage battery to sense its voltage, and transmits the voltage parameter of the storage battery to the above mentioned electric power control unit;

an electric current sensing circuit electrically connected with the L/C harmonic vibration circuit, it can convert the electric current used when in emission of the L/C harmonic vibration circuit into an electric current parameter to be transmitted to the above mentioned electric power control unit;

the electric power control unit is connected respectively with the demodulation circuit, the voltage sensing circuit and the electric current sensing circuit, and can have the voltage parameter, the electric current parameter and the error parameter calculated and gotten electric power mated with that required by the external electronic device through the controlled calculation method (PID), and the electric power then can be converted to a quantity of frequency to render a driving circuit to drive the L/C harmonic vibration circuit for generating a harmonic vibration electric power source to be provided for and accepted by the external electronic device in a wireless mode.

With the above stated circuit combination, by rendering the primary electric power source of the storage battery to pass the electric power source circuit for providing for the electric power control unit (such as CPU) to generate a frequency output which pushes the L/C harmonic vibration circuit through the driving circuit and generates a harmonic vibration electric power source, to be provided for and accepted by the external electronic device and to charge, meantime the voltage sensing circuit transmits the voltage parameter of the storage battery to the electric power control unit.

When the external electronic device receives the harmonic vibration electric power source signal to feed back the error controlled data signal to be received by the L/C harmonic vibration circuit, and convert into an error parameter through the demodulation circuit to be transmitted to the electric power control unit. Meantime the electric current used in emission is converted via the current sensing circuit into an electric current parameter and is transmitted back to the electric power control unit.

After the electric power control unit receives the voltage parameter, the electric current parameter and the error parameter, it can calculate and get electric power mated with that required by the external electronic device through the controlled calculation method (PID), and the electric power can be converted to a quantity of frequency to render a driving circuit to drive the L/C harmonic vibration circuit for generating a suitable harmonic vibration electric power source signal to be provided for and accepted by the external electronic device, and thus the object of having the best conversion of electric power source can be achieved.

The followings further describe the mode of practicing of the various elements:

In practice, the voltage sensing circuit includes an operation dealing unit, the voltage sensed by the voltage sensing circuit through the operation and treatment of the operation dealing unit becomes a voltage parameter which is transmitted to the aforesaid electric power control unit.

In practice, the current sensing circuit includes an amplifying circuit, the current sensing circuit senses the electric current used when the L/C harmonic vibration circuit emits, and the current is converted into a current parameter through the amplifying circuit to be transmitted to the aforesaid electric power control unit.

In practice, the storage battery is electrically connected with an electric charging circuit which further is electrically connected with an electric power source input terminal adapted to be inserted by an external transmitting line, in order that the storage battery can get the external electric power source for charging.

In practice, the storage battery further is electrically connected with an electric discharging voltage rise circuit; the electric discharging voltage rise circuit is electrically connected with the electric power source output terminal adapted to be inserted by an external transmitting line, in order that the storage battery can electrically charge the external electronic device in a wired mode.

And in practice, the external electronic device has a second L/C harmonic vibration circuit for receiving the harmonic vibration electric power source signal of a L/C harmonic vibration circuit in the wireless electric charging module, the second L/C harmonic vibration circuit of the external electronic device further is connected with a rectification wave filtration circuit, a regulation circuit, an error control circuit; the error control circuit can convert the error value in electric charging of the external electronic device into the error control signal through the regulation circuit and the rectification wave filtration circuit, and can transmit the error control signal to the L/C harmonic vibration circuit in the wireless electric charging module through the second L/C harmonic vibration circuit.

As compared with the conventional techniques, the wireless electric charging module of the storage battery of the present invention can use the controlled calculation method (PID) to calculate and get electric power mated with that required by the external electronic device after receiving the voltage parameter, the electric current parameter and the error parameter, and then convert the electric power into a quantity of frequency to be accepted by the external electronic device, in this mode, the object of having the efficient of conversion of the electric power source can be the best.

The present invention will be apparent after reading the detailed description of the preferred embodiment thereof in reference to the accompanying drawings.

### BRIEF DESCRIPTION OF THE DRAWINGS

FIG. 1 is a schematic perspective view showing the present invention uses a storage battery for wireless sending in electricity charging an external electronic device.

FIG. 2 is a schematic view showing a preferred embodiment of a wireless charging module of the storage battery of the present invention.

FIG. 3 is a schematic view showing the action of wireless charging for the present invention and the external electronic device.

FIG. 4 is a schematic view showing an embodiment of electric charging/discharging in a wired mode of the storage battery in practice of the present invention.

### DETAILED DESCRIPTION OF THE PREFERRED EMBODIMENT

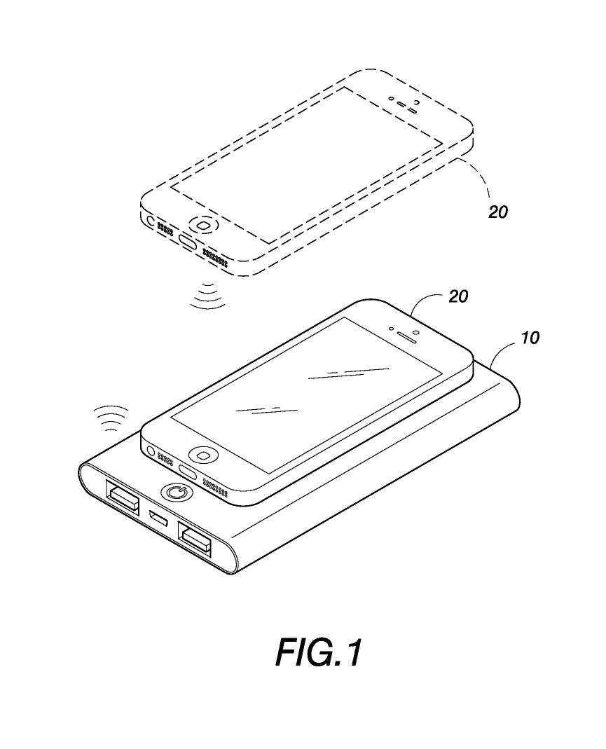

As shown in FIG. 1, the wireless charging module of the storage battery 10 of the present invention is used to control the storage battery 10 to make a direct electric power source for wireless sending in electricity charging an external electronic device 20.

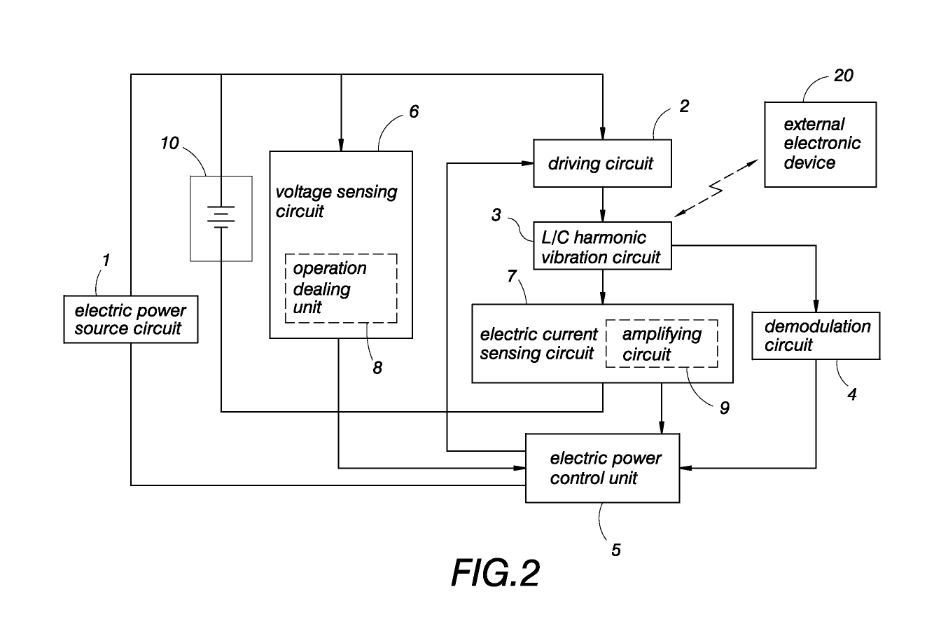

And please refer to FIG. 2, the wireless electric charging module of the storage battery of the present invention includes: an electric power source circuit 1, a driving circuit 2, an L/C harmonic vibration circuit 3, a demodulation circuit 4, an electric power control unit 5, a voltage sensing circuit 6 and an electric current sensing circuit 7.

Wherein the electric power source circuit 1 can convert the electric power stored in the storage battery 10 into a stabilized voltage to be provided for the electric power control unit 5 (such as CPU) in order that the electric power control unit 5 can make a frequency output, and pushes the L/C harmonic vibration circuit 3 through the driving circuit 2.

The L/C harmonic vibration circuit 3 can use the features of the frequency and the curve of the L/C harmonic vibration to convert the electric power transmitted by the driving circuit 2 into a harmonic vibration electric power source signal to be emitted and put out in a wireless mode, and to be provided for the external electronic device 20 for charging; while the L/C harmonic vibration circuit 3 can receive the error controlled data signal transmitted back from the external electronic device 20 (to be described later), and further can transmit to the demodulation circuit 4.

The aforesaid demodulation circuit 4 can demodulate and convert the error controlled data signal received by the L/C harmonic vibration circuit 3 and transmit to the electric power control unit 5.

The voltage sensing circuit 6 which is electrically connected with the storage battery 10 to sense its voltage, and transmits the voltage parameter of the storage battery 10 to the above mentioned electric power control unit 5; in the drawing, the voltage sensing circuit 6 further includes an operation dealing unit 8, the voltage sensed by the voltage sensing circuit 6 through the operation and treatment of the operation dealing unit 8 becomes a voltage parameter which is transmitted to the aforesaid electric power control unit 5.

The electric current sensing circuit 7 converts the electric current used when in emission of the L/C harmonic vibration circuit 3 into an electric current parameter to be transmitted to the above mentioned electric power control unit 5; in the drawing, the current sensing circuit 7 further includes an amplifying circuit 9, the current is converted into a current parameter through the amplifying circuit 9 to be transmitted to the aforesaid electric power control unit 5.

The electric power control unit 5 is connected respectively with the demodulation circuit 4, the voltage sensing circuit 6 and the electric current sensing circuit 7, and can have the voltage parameter, the electric current parameter and the error parameter calculated and gotten electric power mated with that required by the external electronic device 20 through the controlled calculation method (PID), and the electric power then can be converted to a quantity of frequency to control the driving circuit 2 to drive the L/C harmonic vibration circuit 3 for generating a harmonic vibration electric power source signal to be provided for the external electronic device 20 in a wireless mode.

By combination of the above circuits, to render the electric power source of the primary electric power source of the storage battery 10 to pass the electric power source circuit 1 for providing for the electric power control unit 5 (such as CPU) to generate a frequency output which pushes the L/C harmonic vibration circuit 3 through the driving circuit 2 and generates a harmonic vibration electric power source signal, to be provided for and accepted by the external electronic device 20 and for charging, meantime the voltage sensing circuit 6 senses the voltage parameter of the storage battery 10 and transmits to the electric power control unit 5.

When the external electronic device 20 receives the harmonic vibration electric power source signal to feed back the error controlled data signal to be received by the L/C harmonic vibration circuit 3, and convert into an error parameter through the demodulation circuit 4 to be transmitted to the electric power control unit 5. Meantime the electric current used in emission of the L/C harmonic vibration circuit 3 can be converted by the current sensing circuit 7 into an electric current parameter and is transmitted back to the electric power control unit 5.

After the electric power control unit 5 receives the voltage parameter, the electric current parameter and the error parameter, it can calculate and get electric power mated with that required by the external electronic device 20 through the controlled calculation method (PID), and the electric power can be converted to a quantity of frequency to drive the L/C harmonic vibration circuit 3 through the driving circuit 2 for generating a suitable harmonic vibration electric power source signal to be provided for and accepted by the external electronic device 20, thus the object of having the best conversion of electric power source can be achieved.

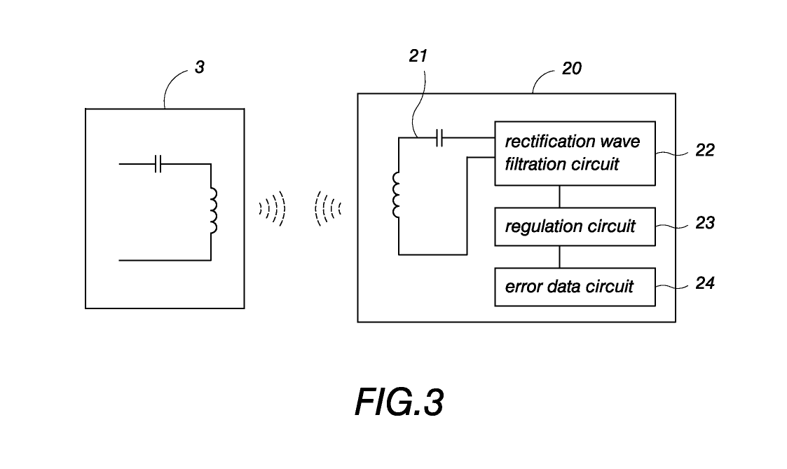

And please refer to FIG. 3, in practice, the external electronic device 20 has a second L/C harmonic vibration circuit 21 for receiving the harmonic vibration electric power source signal of the L/C harmonic vibration circuit 3 in the wireless electric charging module, the second L/C harmonic vibration circuit 21 of the external electronic device 20 further is connected with a rectification wave filtration circuit 22, a regulation circuit 23, an error data circuit 24; the error data circuit 24 can convert the error value in electric charging of the external electronic device 20 into the error control signal through the regulation circuit 23 and the rectification wave filtration circuit 22, and can transmit the error control signal to the L/C harmonic vibration circuit 3 in the wireless electric charging module through the second L/C harmonic vibration circuit 21.

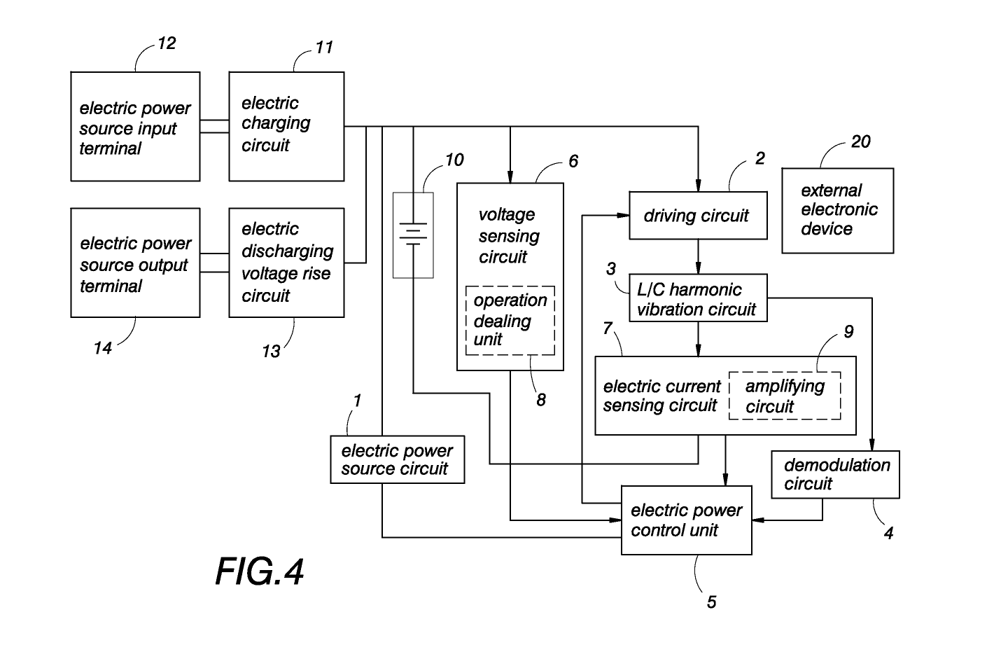

As shown in FIG. 4, in practice, the storage battery 10 is electrically connected with an electric charging circuit 11 which further is electrically connected with an electric power source input terminal 12 adapted to be inserted by an external transmitting line, in order that the storage battery 10 can get the external electric power source for charging.

In the drawing, the storage battery 10 further is electrically connected with an electric discharging voltage rise circuit 13; the electric discharging voltage rise circuit 13 is connected with the electric power source output terminal 14 adapted to be inserted by an external transmitting line, in order that the storage battery 10 can electrically charge the external electronic device 20 in a wired mode.

The embodiments and the drawings given are only for illustrating the present invention, and not for giving any limitation to the scope of the present invention; it will be apparent to those skilled in this art that various modifications or changes without departing from the spirit of this invention shall also fall within the scope of the appended claims.

1. A wireless electric charging module for a storage battery, said wireless electric charging module is used to make said storage battery an electric power source for wireless sending in electricity charging, and is used for wireless charging of an external electronic device; wherein said external electronic device has a function of receiving electric power in a wireless mode, and is adapted to transmit back an error controlled data signal; said wireless electric charging module of said storage battery includes:
an electric power source circuit adapted to convert said electric power stored in said storage battery into a stabilized voltage to be provided for use of said electric power control unit, in order that said electric power control unit generates a frequency output which pushes an L/C harmonic vibration circuit through a driving circuit;
said L/C harmonic vibration circuit is adapted for using features of frequency and curve of said L/C harmonic vibration circuit to convert electric power transmitted by said driving circuit into a harmonic vibration electric power source signal to be emitted and put out in a wireless mode, and said L/C harmonic vibration circuit is adapted for receiving an error controlled data signal transmitted back from said external electronic device, and further transmits to a demodulation circuit;
said demodulation circuit is adapted for demodulating and converting said error controlled data signal received by said L/C harmonic vibration circuit and transmit to said electric power control unit;
a voltage sensing circuit which is electrically connected with the storage battery to sense its voltage, and transmits a voltage parameter of said storage battery to said electric power control unit;
an electric current sensing circuit electrically connected with said L/C harmonic vibration circuit, it is adapted for converting electric current used when in emission of said L/C harmonic vibration circuit into an electric current parameter to be transmitted to said electric power control unit;
said electric power control unit is connected respectively with said demodulation circuit, said voltage sensing circuit and said electric current sensing circuit, and is adapted for having said voltage parameter, said electric current parameter and an error parameter calculated and gotten electric power mated with that required by said external electronic device through said controlled calculation method (PID), said electric power then is converted to a quantity of frequency to render said driving circuit to drive said L/C harmonic vibration circuit for generating a harmonic vibration electric power source to be provided for and accepted by said external electronic device in a wireless mode.

2. The wireless electric charging module for a storage battery as in claim 1, wherein: said voltage sensing circuit includes an operation dealing unit, voltage sensed by said voltage sensing circuit through operation and treatment of said operation dealing unit becomes a voltage parameter which is transmitted to said electric power control unit.

3. The wireless electric charging module for a storage battery as in claim 1, wherein: said current sensing circuit includes an amplifying circuit, said current sensing circuit senses electric current used when said L/C harmonic vibration circuit emits, and said current is converted into a current parameter through said amplifying circuit to be transmitted to said electric power control unit.

4. The wireless electric charging module for a storage battery as in claim 1, wherein: said storage battery is electrically connected with an electric charging circuit which further is electrically connected with an electric power source input terminal adapted to be inserted by an external transmitting line, in order that said storage battery gets said external electric power source for charging.

5. The wireless electric charging module for a storage battery as in claim 4, wherein: said storage battery further is electrically connected with an electric discharging voltage rise circuit; said electric discharging voltage rise circuit is electrically connected with an electric power source output terminal adapted to be inserted by an external transmitting line, in order that said storage battery electrically charges said external electronic device in a wired mode.

6. The wireless electric charging module for a storage battery as in claim 5, wherein: said external electronic device has a second L/C harmonic vibration circuit for receiving a harmonic vibration electric power source signal of said L/C harmonic vibration circuit in said wireless electric charging module, said second L/C harmonic vibration circuit of said external electronic device further is connected with a rectification wave filtration circuit, a regulation circuit, an error data circuit; said error data circuit is adapted for converting error value in electric charging of said external electronic device into an error control signal through said regulation circuit and said rectification wave filtration circuit, and transmits said error control signal to said L/C harmonic vibration circuit in said wireless electric charging module through said second L/C harmonic vibration circuit.

7. The wireless electric charging module for a storage battery as in claim 2, wherein: said storage battery is electrically connected with an electric charging circuit which further is electrically connected with an electric power source input terminal adapted to be inserted by an external transmitting line, in order that said storage battery gets said external electric power source for charging.

8. The wireless electric charging module for a storage battery as in claim 7, wherein: said storage battery further is electrically connected with an electric discharging voltage rise circuit; said electric discharging voltage rise circuit is electrically connected with an electric power source output terminal adapted to be inserted by an external transmitting line, in order that said storage battery electrically charges said external electronic device in a wired mode.

9. The wireless electric charging module for a storage battery as in claim 8, wherein: said external electronic device has a second L/C harmonic vibration circuit for receiving a harmonic vibration electric power source signal of said L/C harmonic vibration circuit in said wireless electric charging module, said second L/C harmonic vibration circuit of said external electronic device further is connected with a rectification wave filtration circuit, a regulation circuit, an error data circuit; said error data circuit is adapted for converting error value in electric charging of said external electronic device into an error control signal through said regulation circuit and said rectification wave filtration circuit, and transmits said error control signal to said L/C harmonic vibration circuit in said wireless electric charging module through said second L/C harmonic vibration circuit.

10. The wireless electric charging module for a storage battery as in claim 3, wherein: said storage battery is electrically connected with an electric charging circuit which further is electrically connected with an electric power source input terminal adapted to be inserted by an external transmitting line, in order that said storage battery gets said external electric power source for charging.

11. The wireless electric charging module for a storage battery as in claim 10, wherein: said storage battery further is electrically connected with an electric discharging voltage rise circuit; said electric discharging voltage rise circuit is electrically connected with said electric power source output terminal adapted to be inserted by an external transmitting line, in order that said storage battery can electrically charge said external electronic device in a wired mode.

12. The wireless electric charging module for a storage battery as in claim 11, wherein: said external electronic device has a second L/C harmonic vibration circuit for receiving a harmonic vibration electric power source signal of said L/C harmonic vibration circuit in said wireless electric charging module, said second L/C harmonic vibration circuit of said external electronic device further is connected with a rectification wave filtration circuit, a regulation circuit, an error data circuit; said error data circuit is adapted for converting error value in electric charging of said external electronic device into an error control signal through said regulation circuit and said rectification wave filtration circuit, and transmits said error control signal to said L/C harmonic vibration circuit in said wireless electric charging module through said second L/C harmonic vibration circuit.
